(19) United States
(12) Patent Application Publication
(10) Pub. No.: US 2023/0262116 A1
(43) Pub. Date: Aug. 17, 2023

(54) NETWORK DEVICE, NETWORK DEVICE CONTROL METHOD, AND NETWORK SYSTEM

(71) Applicant: Sony Group Corporation, Tokyo (JP)

(72) Inventors: Kazuaki TOBA, Kanagawa (JP); Hiroshi MORITA, Kanagawa (JP); Masanari YAMAMOTO, Kanagawa (JP)

(73) Assignee: Sony Group Corporation, Tokyo (JP)

(21) Appl. No.: 18/014,414

(22) PCT Filed: Aug. 11, 2021
(86) PCT No.: PCT/JP2021/029590

§ 371 Date: Jan. 4, 2023

(30) Foreign Application Priority Data
Aug. 19, 2020 (JP) 2020-138799

(51) Int. Cl. H04L 67/1042; H04L 67/143; H04L 67/141

(52) U.S. Cl. CPC H04L 67/1042; H04L 67/143; H04L 67/141

(57) ABSTRACT

This invention satisfactorily prevents another person from accessing a terminal that is in use, without reducing a bandwidth allocated to a dedicated peer-to-peer path for the terminal that is in use. A controller controls processing of receiving a request from a first terminal for connection to a second terminal, and processing of transmitting, when the second terminal is in use, a notification that connection cannot be established to the first terminal. For example, the controller recognizes that the second terminal is in use on the basis of connection information stored in a storage unit or on the basis of connection information received from another network device that transmits the request for connection to the second terminal transmitted from the first terminal.

### TECHNICAL FIELD

The present technology relates to a network device, a network device control method, and a network system, and relates to a network device and the like that can satisfactorily prevent another person from accessing a terminal that is in use.

### BACKGROUND ART

A known network has a function of notifying, in a case of waiting for, for example, output from a printer, a terminal that has issued a task that the task is waiting in an output queue (see, for example, Patent Document 1). Furthermore, for example, in a case of joint editing of a file in a file server over a network, there is a function available with which to notify another person who tries to edit a file being edited that the file is being edited and cannot be edited.

Such functions are performed in the end by a printer or a file server processing requests from a plurality of sources, and time division control is applied to control for the functions, so that it is necessary for the printer or the file server to perform such processing in parallel with printing or editing processing, and some of the bandwidth is allocated to the control.

### CITATION LIST

### Patent Document

Patent Document 1: Japanese Patent Application Laid-Open No. H08-292850

### SUMMARY OF THE INVENTION

### Problems to be Solved by the Invention

It is therefore an object of the present technology to satisfactorily prevent another person from accessing a terminal that is in use without reducing a bandwidth allocated to a dedicated peer-to-peer path for the terminal that is in use.

### Solutions to Problems

Provided according to a concept of the present technology is
a network device including
a controller that controls processing of receiving a request from a first terminal for connection to a second terminal, and processing of transmitting, when the second terminal is in use, a notification that connection cannot be established to the first terminal.

In the present technology, the controller controls the processing of receiving the request from the first terminal for connection to the second terminal, and processing of transmitting, when the second terminal is in use, the notification that connection cannot be established to the first terminal. For example, the controller may recognize that the second terminal is in use on the basis of connection information stored in a storage unit. Furthermore, for example, the controller may recognize that the second terminal is in use on the basis of connection information received from another network device that transmits the request for connection to the second terminal transmitted from the first terminal.

As described above, in the present technology, when the second terminal is in use, the notification that connection cannot be established is transmitted to the first terminal. It is possible to satisfactorily prevent, without causing the terminal that is in use to transmit a notification that connection cannot be established to the other person in response to the request for connection from the other person, the other person from accessing the terminal that is in use without reducing the bandwidth allocated to the dedicated peer-to-peer path for the terminal that is in use.

Furthermore, provided according to another concept of the present technology is
a network device present on a connection path between first terminal and a second terminal, the network device including
a controller that controls processing of receiving a request from a third terminal for connection to the first terminal, and processing of transmitting, when receiving the request for connection, a release request to the second terminal.

In the present technology, the network device is present on the connection path between the first terminal and the second terminal. The controller controls the processing of receiving the request from the third terminal for connection to the first terminal, and the processing of transmitting, when receiving the request for connection, the release request to the second terminal.

As described above, in the present technology, when receiving the request from the third terminal for connection to the first terminal, the release request is transmitted to the second terminal. It is possible to satisfactorily arbitrate, without causing the terminal that is in use to transmit the release request in response to the request for connection from the other person, access from the other person to the terminal that is in use without reducing the bandwidth allocated to the dedicated peer-to-peer path for the terminal that is in use.

Note that, in the present technology, for example, the controller may further control, when transmitting the release request to the second terminal, processing of transmitting, to the third terminal, a notification that the release request has been issued. In this case, the third terminal can recognize that arbitration is ongoing and output a UI screen indicating that arbitration is ongoing, for example.

Furthermore, in the present technology, for example, the controller may further control, when transmitting the release request to the second terminal, processing of receiving a response to the release request from the second terminal. In this case, for example, the controller may further control, when the response from the second terminal indicates non-release, processing of transmitting a notification that connection cannot be established to the third terminal. In this case, it is possible to satisfactorily prevent, without causing the terminal that is in use to transmit a notification that connection cannot be established to the other person in response to the request for connection from the other person, the other person from accessing the terminal that is in use without reducing the bandwidth allocated to the dedicated peer-to-peer path for the terminal that is in use.

Furthermore, in this case, for example, the controller may further control, when the response from the second terminal indicates release, processing of transmitting a notification to at least a network device on the connection path between the first terminal and the second terminal. This allows, as a result of the arbitration, the third terminal and the first terminal to be connected to each other.

Furthermore, provided according to another concept of the present technology is a network system including a predetermined number of network devices interposed between terminals, in which, among the predetermined number of network devices, at least the network device present on a connection path between a first terminal and a second terminal holds information regarding the connection path.

In the present technology, the network system includes the predetermined number of network devices interposed between terminals. For example, the predetermined number of network devices may include a network unit and a switch/router. Here, among the predetermined number of network devices, at least the network device present on the connection path between the first terminal and the second terminal holds information regarding the connection path.

As described above, in the present technology, among the predetermined number of network devices, at least the network device present on the connection path between the first terminal and the second terminal holds information regarding the connection path. This allows the network device holding the information regarding the connection path between the first terminal and the second terminal to transmit, in a case where the request from the third terminal for connection to the first terminal is received, a notification that connection cannot be established because the first terminal is in use to the third terminal. It is therefore possible to satisfactorily prevent, without causing the terminal that is in use to transmit a notification that connection cannot be established to the other person in response to the request for connection from the other person, the other person from accessing the terminal that is in use without reducing the bandwidth allocated to the dedicated peer-to-peer path for the terminal that is in use.

### BRIEF DESCRIPTION OF DRAWINGS

FIG. 1 is a diagram for describing an outline of an example of a network system.

FIG. 2 is a diagram illustrating an example of typical wired connection between devices.

FIG. 3 is a diagram illustrating a configuration example of a network system, illustrating a use case of enjoying video content over a network.

FIG. 4 is a diagram illustrating a configuration example of a network system, illustrating a use case of controlling a robot over a network.

FIG. 5 is a diagram illustrating an example of a UI screen output on a display.

FIG. 6 is a diagram illustrating a schematic configuration example of a node (optical network unit, optical switch/router).

FIG. 7 is a diagram illustrating a schematic configuration example of a set-top box.

FIG. 8 is a diagram illustrating a schematic configuration example of the display.

FIG. 9 is a flowchart illustrating an example of an operation in a case where, with a path from a sink to a source occupied by a node on the path, a request for connection to the source is issued from another sink.

FIG. 10 is a diagram illustrating an example of the UI screen output on the display.

FIG. 11 a diagram illustrating an example of the UI screen output on the display.

FIG. 12 is a diagram illustrating an example of the UI screen output on the display.

FIG. 13 is a flowchart illustrating an example of an operation in a case where, with a path from a sink to a source occupied by a node on the path, a request for connection to the source is issued from another sink.

FIG. 14 is a flowchart illustrating an example of the operation in a case where, with a path from a sink to a source occupied by a node on the path, a request for connection to the source is issued from another sink.

### MODE FOR CARRYING OUT THE INVENTION

Hereinafter, modes for carrying out the present invention (hereinafter, referred to as embodiments) will be described. Note that the description will be given in the following order.

1. Embodiment

2. Modification

### 1. Embodiment

[Description of Related Art]

For recent backbone communications, as optical fiber technology progresses, space multiplexing technology using a multi-core fiber, a multi-mode fiber, and wavelength multiplexing technology progresses. This allows a large number of independent signals to be transmitted through a single fiber.

As this technology further progresses, even communications using a general backbone communications network can occupy a path to establish peer-to-peer connection. That is, a switch or a router on a path selects a path between both connection destinations using a core, a mode, or a wavelength as a dedicated line each time, so that the peer-to-peer connection can be established.

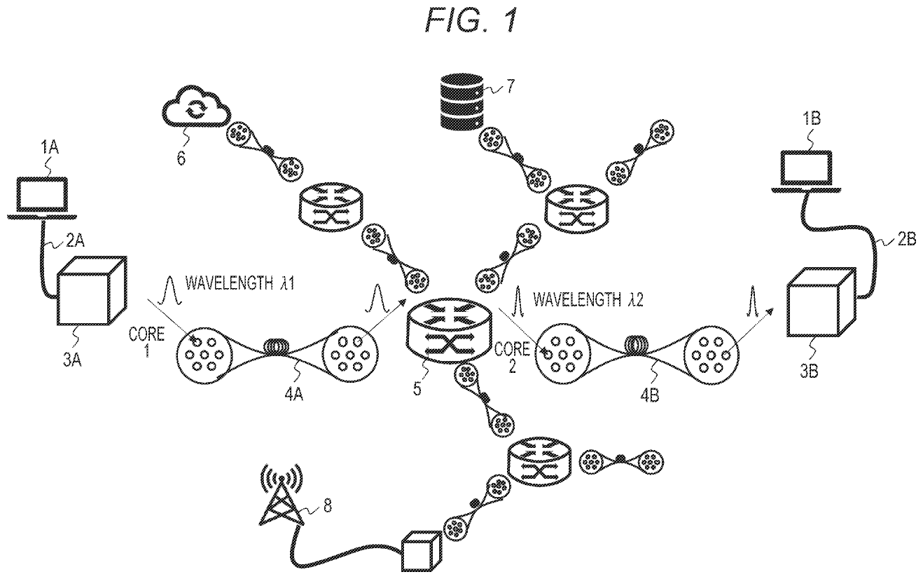

An outline of an example of a network system will be described with reference to FIG. 1. Consider a case where communications are performed between a terminal 1A and a terminal 1B. The terminal 1A is connected to an optical network unit (ONU) 3A over a network cable 2A. On the other hand, the terminal 1B is connected to an optical network unit 3B over a network cable 2B.

The optical network unit 3A and the optical network unit 3B constitute a backbone core network. The backbone core network includes multi-core fibers 4A, 4B and an optical switch/router 5, and is further connected to a cloud 6, a storage 7, a wireless base station 8, and the like to serve as a network that allows devices to connect to each other and communicate with each other.

Here, a signal from the terminal 1A is entered from the optical network unit 3A into a core 1 of the multi-core fiber 4 using a wavelength. This signal is then entered, by the optical switch/router 5, into a core 2 of the multi-core fiber 4B using a wavelength λ2 and is output from the optical network unit 3B to the terminal device 1B.

On this path, the optical switch/router 5 switches cores or wavelengths, but the path is not shared with another terminal at some midpoint between the terminal 1A and the terminal 1B and is determined to be a transfer path as a dedicated line.

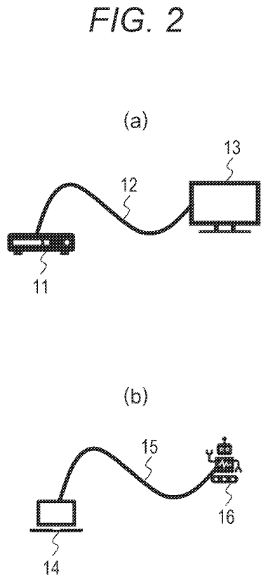

In a case where the network is constructed with such a configuration, for example, the connection between the terminal 1A and the terminal 1B can be regarded as if being similar to typical wired connection between devices. For example, as illustrated in FIG. 2(a), a use case of enjoying video content on a display 13 connected to a set-top box 11 over a high-definition multimedia interface (HDMI) cable 12, as illustrated in FIG. 2(b), a use case of controlling, by a personal computer (PC) 14, a robot 16 connected to the PC 14 over a universal serial bus (USB) cable 15, and the like can be realized over a network.

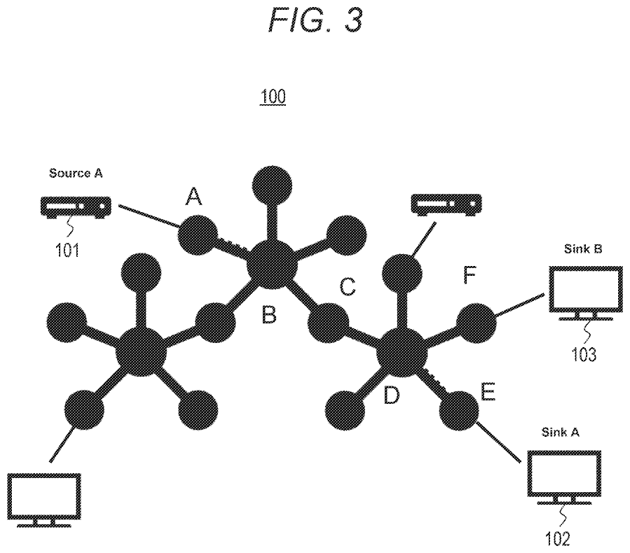

A network system 100 illustrated in FIG. 3 corresponds to a use case of enjoying video content over a network. Each black dot in the drawing represents a node (an optical network unit or an optical switch/router) on the network. A set-top box 101 corresponding to a source A is connected to a display 102 corresponding to a sink A at an optical network unit E via an optical network unit A and optical switches/routers B to D.

In this case, in the optical switches/routers B to D on the path, a selectively exclusive core/wavelength/mode or the like serves as a dedicated line, thereby allowing the source A and the sink A to connect to each other in a peer-to-peer manner. As a result, a dedicated path having a guaranteed bandwidth through which a video stream flows from the source A to the sink A is prepared, and the same experience as in the use case of enjoying video content from the set-top box 11 to the display 13 over the HDMI cable 12 illustrated in FIG. 2 (a) can be realized.

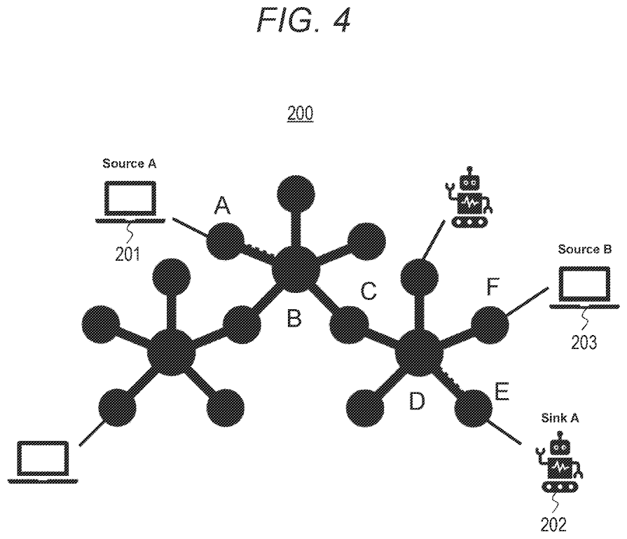

A network system 200 illustrated in FIG. 4 corresponds to a use case of controlling a robot over a network. As in FIG. 3, each black dot in the drawing represents a node (an optical network unit or an optical switch/router) on the network. A PC 201 corresponding to a source A is connected to a robot 202 corresponding to a sink A at an optical network unit E via an optical network unit A and optical switches/routers B to D.

In this case, in the optical switches/routers B to D on the path, a selectively exclusive core/wavelength/mode or the like serves as a dedicated line, thereby allowing the source A and the sink A to connect to each other in a peer-to-peer manner. As a result, a dedicated path having a guaranteed bandwidth through which control information flows from the source A to the sink A is prepared, and the same experience as in the use case of controlling the robot 16 from the PC 14 over the USB cable 15 illustrated in FIG. 2(b) can be realized.

The connections illustrated in FIGS. 2(a) and 2(b) allow a user to clearly recognize their respective connection destinations. In a case of connections over the network illustrated in FIGS. 3 and 4, however, the user cannot clearly recognize the connections.

For example, in FIG. 3, even if a viewer/listener of a display 103 of a sink B desires to establish connection to the set-top box 101 of the source A, the viewer/listener cannot clearly recognize that the set-top box 101 of the source A is in use by the display 102 of the sink A. Furthermore, for example, in FIG. 4, even if an operator of a PC 203 of a source B desires to establish connection to the robot 202 of the sink A, the operator cannot clearly recognize that the robot 202 of the sink A is in use by an operator of the PC 201 of the source A.

As in a known network system, in order to cause the set-top box, the robot, or the like to perform processing on a request for connection, it is necessary not only to implement an arbitration function in the set-top box, the robot, or the like for the use cases illustrated in FIGS. 2(a) and 2(b), but also to allocate, to corresponding control, a dedicated peer-to-peer bandwidth in a time division manner or the like.

[Description of First Embodiment]

A first embodiment will be described with reference to the network system 100 illustrated in FIG. 3.

When the display 103 of the sink B desires to reproduce a video stream of the set-top box 101 of the source A and tries to route a path from an optical network unit F to the optical network unit A via the optical switch/router D, it can be seen that the path to the optical network unit A is in use from a state of the optical switch/router D.

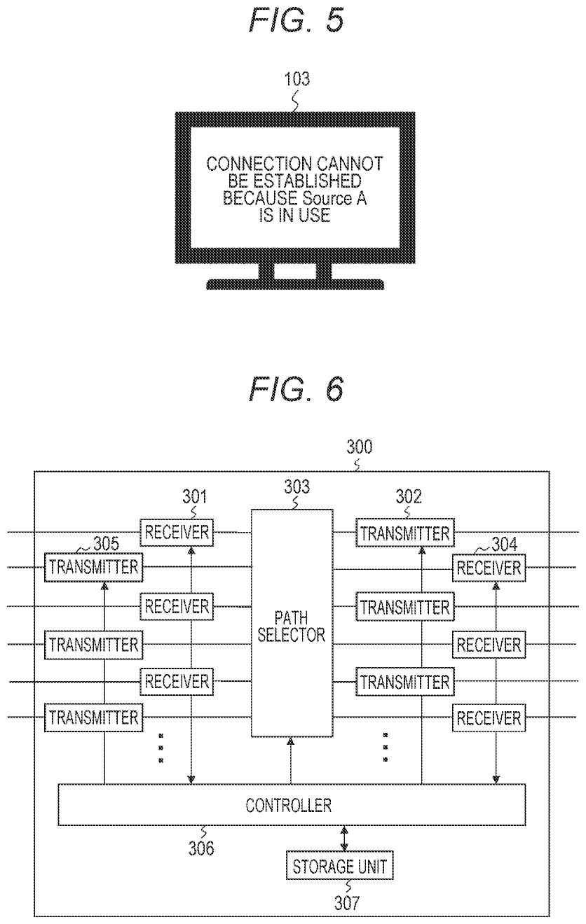

This allows the optical network unit F to notify the display 103 of the sink B that connection cannot be established because the path is in use. In this case, for example, a screen as illustrated in FIG. 5 is output on the display 103 of the sink B, which allows the viewer/listener of the display 103 of the sink B to clearly recognize that connection cannot be established because the set-top box 101 of the source A is in use.

An operation in a case where a path is occupied between the set-top box 101 of the source A and the display 102 of the sink A in the network system 100 illustrated in FIG. 3 will be described.

FIG. 6 illustrates a schematic configuration example of a node (optical network unit, optical switch/router) 300. Here, it is assumed that an optical network unit is connected to a plurality of optical switches/routers and connected to a plurality of terminals to operate like a switch/router, and therefore the optical network unit is similar in configuration to an optical switch/router. A network device corresponding to the optical network unit and the optical switch/router is referred to as a node regarded as being a repeater in the network as needed.

The node 300 includes receivers 301 that each receive a signal transmitted through a corresponding one of a plurality of paths, transmitters 302 that each transmit the signal to a corresponding path leading to a destination, and a path selector 303 that switches paths, wavelengths, or cores between the plurality of receivers 301 and the plurality of transmitters 302 to allow a path between terminals to be occupied.

The node 300 further includes a plurality of receivers 304 that is provided corresponding to the plurality of transmitters 302 and perform communications for establishing connection, and a plurality of transmitters 305 that is provided corresponding to the plurality of receivers 301 and perform communications for establishing connection. The node 300 further includes a controller 306 that controls each unit of the node 300 and a storage unit 307 that stores information handled by the controller 306.

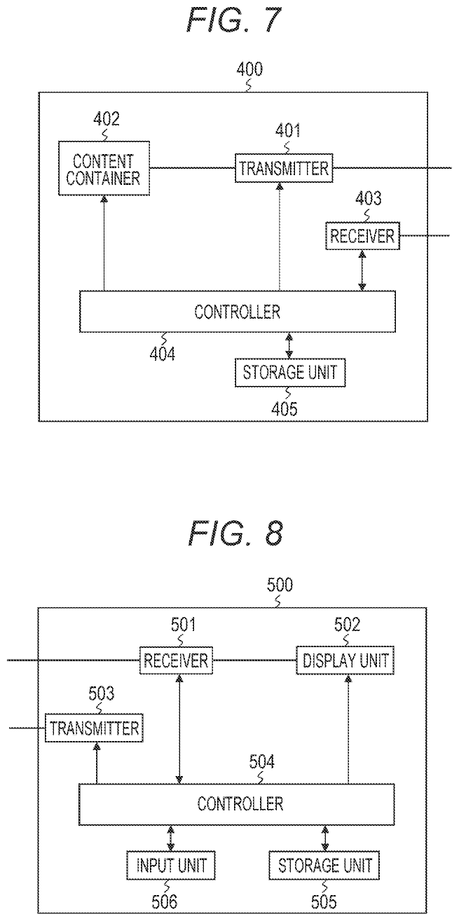

FIG. 7 illustrates a schematic configuration example of a set-top box 400 (the set-top box 101 or the like). The set-top box 400 includes a transmitter 401, a content container 402 that outputs a video signal to the transmitter 401, and a receiver 403 that performs communications for establishing connection. The set-top box 400 further includes a controller 404 that controls each unit of the set-top box 400 and a storage unit 405 that stores information handled by the controller 404.

FIG. 8 illustrates a schematic configuration example of a display 500 (the displays 102, 103, or the like). The display 500 includes a receiver 501, a display unit 502 that outputs a video based on a video signal received by the receiver 501, and a transmitter 503 that performs communications for establishing connection. The display 500 further includes a controller 504 that controls each unit of the display 500, a storage unit 505 that stores information handled by the controller 504, and an input unit 506 such as a remote controller that receives a request from a viewer/listener (user).

First, an operation for establishing connection in which nodes E, D, C, B, A on the path sequentially process a request for connection containing address information of the set-top box 101 of the source A from the display 102 of the sink A to secure a path that can be occupied will be described.

The display 102 (see FIG. 8) of the sink A causes the controller 504 to generate address information on the basis of information regarding the network stored in the storage unit 505, and causes the transmitter 503 to transmit, to the node E, a request for connection to the set-top box 101 of the source A.

The node E (see FIG. 6) causes the controller 306 to compare the request for connection containing the address information of the set-top box 101 of the source A received by the receiver 304 from the display 102 of the sink A with the network information stored in the storage unit 307 to cause the path selector 303 to select an unused wavelength or core from among paths between the node E and the node D so as to connect the node E to the node D that is located upstream of the node E with respect to the set-top box 101 of the source A and to which the node E is connected, and then causes the transmitter 305 to transmit the request for connection containing the address information of the set-top box 101 of the source A to the node D. At this time, the node E adds, to the request for connection containing the address information of the set-top box 101 of the source A, information indicating that that path passes from the display 102 of the sink A via the node E.

Next, as with the node E described above, the node D adds information indicating that the path passes from the display 102 of the sink A via the node E and the node D and transmits the request for connection containing the address information of the set-top box 101 of the source A to the node C that is located upstream of the node D with respect to the set-top box 101 of the source A and to which the node D is connected.

Hereinafter, the node C, the node B, and the node A operate in a similar manner. Finally, the node A performs communications with the receiver 403 of the set-top box 101 (see FIG. 7) of the source A to establish connection, thereby establishing connection from the display 102 of the sink A to the set-top box 101 of the source A via the nodes E, D, C, B, A.

When connection is established as described above, the controller 404 of the set-top box 101 (see FIG. 7) of the source A refers to the network information stored in the storage unit 405 to generate address information of the display 102 of the sink A and causes the transmitter 401 to transmit the address information together with the video signal stored in the content container 402. As a result, the video signal is transmitted to the display 102 of the sink A via the nodes A, B, C, D, E.

Note that, in the above description, a notification of information regarding the path from the display 102 of the sink A to the set-top box 101 of the source A is provided, with, when each connection between the nodes is established, information regarding each node added to the information regarding the path up to the node. In this case, each node on the path has information regarding the path occupied by corresponding connection. At the end of the establishment of connection as the path from the node A to the node E, this information may be shared again among the nodes on the path, or the entire network may be notified of the information. This information is stored in, for example, the storage unit 307 of each node.

Next, an operation when the display 102 of the sink B attempts to establish connect on to the set-top box 101 of the source A with connection that is occupied via the nodes A to E between the set-top box 101 of the source A and the display 102 of the sink A established and the transmission of the video signal from the set-top box 101 of the source A to the display 102 of the sink A in progress will be described.

The display 103 (see FIG. 8) of the sink B causes the controller 504 to generate address information on the basis of the information regarding the network in the storage unit 505 in response to a request from the viewer/listener (user) to the input unit 506, and causes the transmitter 503 to transmit, to the node F, a request for connection to the set--top box 101 of the source A.

Upon receipt of the request for connection containing the address information, the node F (see FIG. 6) refers to the information regarding the network in the storage unit 307, and causes the transmitter 305 to transmit the request for connection containing the address information to the node D that is an upstream node with respect to the set-top box 101 of the source A. Upon receipt of the request for connection containing the address information by the receiver 304, the node D (see FIG. 6) causes the controller 306 to generate information indicating that connection cannot be established on the basis of information in the storage unit 307 indicating that the path to the set-top box 101 of the source A is already occupied and causes the transmitter 302 to transmit the information to the node F.

Upon receipt of the information indicating that connection cannot be established from the node D, the node F transmits the information to the display 103 of the sink B to request the display 103 to notify the viewer/listener (user) that connection cannot be established because the set-top box 101 of the sink A is in use. In this case, the display 103 of the sink B outputs a screen indicating that connection cannot be established because the set-top box 101 of the source A is in use (see FIG. 5), and cancels the request for connection to the set-top box 101 of the source A. Here, the screen information may be generated by the controller 504 of the display 103 of the sink B, or may be supplied with the screen information contained in the information from the node F indicating that connection cannot be established.

Note that a description has been given above that the path from the display 102 of the sink A to the set-top box 101 of the source A is recognized as being occupied by the nodes A to E on path, but, as described above, in a case where the information regarding the above is shared all over the network, the node F can transmit the information indicating that connection cannot be established to the display 103 of the sink B on the basis of the connection information stored in its own storage unit 307 without attempting to establish connection to the node D.

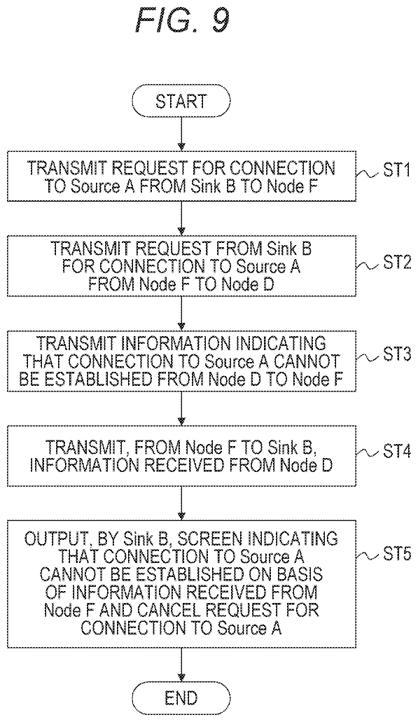

The flowchart in FIG. 9 illustrates an example of an operation in a case where a request for connection to the source A is issued from the sink B (display 103) with the path from the sink A (display 102) to the source A (set-top box 101) occupied by the nodes A to E on the path as described above.

First, in step ST1, the sink B transmits, to the node F, a request for connection to the source A. Next, in step ST2, the node F transmits, to the node D, the request from the sink B for connection to the source A.

Next, in step ST3, the node D transmits, to the node F, information indicating that connection to the source A cannot be established because the source A is in use. Next, in step ST4, the node F transmits, to the sink B, the information received from the node D. Next, in step ST5, the sink B outputs a screen indicating that connection to the source A cannot be established on the basis of the information received from the node D (see FIG. 5), and cancels the request for connection to the source A.

Note that, in a case where the information indicating that the path from the display 102 of the sink A to the set-top box 101 of the source A is occupied by the nodes A to E on the path is shared all over the network, the node F can transmit the information indicating that connection cannot be established to the sink B without attempting to establish connection to the node D as described above, so that, in this case, the processing in steps 2, 3 is skipped in the flowchart in FIG. 9.

As described above, in the present technology, connection to an occupied path is rejected through communications with an adjacent node without performing communications with a terminal device. That is, in the present technology, it is possible to prevent another person from accessing a terminal that is in use without implementing an arbitration function in the terminal and without reducing a bandwidth allocated to a dedicated peer-to-peer path.

Note that, although no detailed description will be given, in the network system 200 illustrated in FIG. 4, in a case where the PC 203 of the source B transmits, to the node F, a request for connection to the robot 202 of the sink A with connection that is occupied via the nodes A to E between the PC 201 of the source A and the robot 202 of the sink A established, and the robot 202 of the sink A being under the control of (operated by) the PC 201 of the source A, the node F can transmit, to the PC 203 of the source B, information indicating that connection to the robot 202 of the sink A cannot be established because the robot 202 is in use in a similar manner.

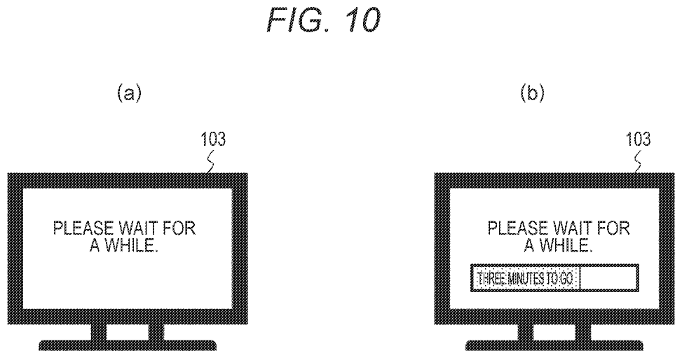

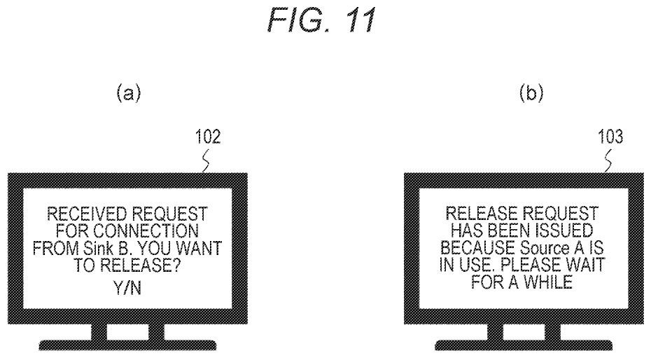

Furthermore, an example where connection cannot be established in a case where it is use has been described above, but more complicated arbitration may be performed. For example, in a case where it is already known that the set-top box 101 of the source A will be released in a certain period of time, a screen as illustrated in FIG. 10(a) may be output on the display 103 of the sink B so as to hold the establishment of connection on standby for a while, and, in this case, the standby time may be displayed as illustrated in FIG. 10(b).

[Description of Second Embodiment]

A second embodiment will be described with reference to the network system 100 illustrated in FIG. 3.

When the display 103 or the sink B desires to reproduce the video stream of the set-top box 101 of the source A and tries to route a path from the node F to the node A via the node D, it can be seen that the path to the node A is in use from a state of the node D.

The node D issues a release request to the display 102 of the sink A through the node E. In this case, for example, a screen as illustrated in FIG. 11(a) is output on the display 102 of the sink A so as to prompt the viewer/listener (user) of the display 102 of the sink A to select release or non-release. Furthermore, in this case, for example, a screen as illustrated in FIG. 11(b) is output on the display 103 of the sink B so as to cause the viewer/listener (user) or the display 103 or the sink B to recognize that the set-top box 101 of the source A is in use, and the release request has been issued.

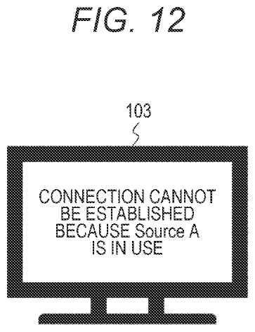

When a response from the display 102 of the sink A indicates non-release, the node D notifies the display 103 of the sink B via the node F that connection cannot be established because it is in use. In this case, for example, a screen as illustrated in FIG. 12 is output on the display 103 of the sink B so as to allow the viewer/listener of the display 103 of the sink B to clearly recognize that connection cannot be established because the set-top box 101 of the source A is in use.

On the other hand, when the response from the display 102 of the sink A indicates release, the connection between The display 102 of the sink A and the set-top box 101 of the source A as released, and the connection between the display 103 of the sink B and the set-top box 101 of the source A is established, so as to allow the set-top box 101 of the source A to transmit the video signal to the display 103 of the sink B.

The operation of establishing connection of the path from the display 102 of the sink A to the set-top box 101 of the source A is similar to the operation described in the first embodiment, so that no description will be given below of the operation.

An operation when the display 103 of the sink B attempts to establish connection to the set-top box 101 of the source A with connection that is occupied via the nodes A to E between the set-top box 101 of the source A and the display 102 of the sink A established, and the transmission of the video signal from the set-top box 101 of the source A to the display 102 of the sink A in progress will be described.

The display 103 (see FIG. 8) of the sink causes the controller 504 to generate address information on the basis of the information regarding the network in the storage unit 505 in response to a request from the viewer/listener (user) to the input unit 506, and causes the transmitter 503 to transmit, to the node F, a request for connection to the set-top box 101 of the source A.

Upon receipt of the request for connection containing the address information, the node F (see FIG. 6) refers to the information regarding the network in the storage unit 307, and causes the transmitter 305 to transmit the request for connection containing the address information to the node D that is an upstream node with respect to the set-top box 101 of the source A.

Upon receipt of the request for connection containing the address information by the receiver 304, the node D (see FIG. 6) causes, on the basis of the information in the storage unit 307 indicating that the path to the set-top box 101 of the source A is already occupied, the transmitter 302 to transmit the release request addressed to the display 102 of the sink A to the node E that is a downstream node relative to the display 102 of the sink A.

Upon receipt of the release request from the node D, the node E transmits the release request to the display 102 of the sink A, and requests the viewer/listener (user) of the display 102 of the sink A to select release or non-release. In this case, the display 102 of the sink A outputs a screen prompting the viewer/listener (user) of the display 102 of the sink A to select release or non-release (see FIG. 11(a)). Here, the screen information may be generated by the controller 504 of the display 102 of the sink A, or may be supplied with the screen information contained in the release request from the node E.

Furthermore, the node D that has transmitted the release request to the node E transmits, to the node F, information addressed to the display 103 of the sink B indicating that the source A is in use, and the release request has been issued. Upon receipt of the information from the node D, the node F transmits the information to the display 103 of the sink B.

The display 103 of the sink B outputs, on the basis of this information (see FIG. 11(b)), a screen indicating that the set-top box 101 of the source 101 is in use, and the release request has been issued. Here, the screen information may be generated by the controller 504 of the display 103 of the sink B, or may be supplied with the screen information contained in the information from the node F. This screen causes the viewer/listener (user) of the sink B to recognize that the set-top box 101 of the source A is in use, and the release request has been issued.

The display 102 (see FIG. 8) of the sink A causes the controller 504 to generate a response to the release request, the response being addressed to the node D, in accordance with response operation of the input unit 506 made by the viewer/listener (user), and causes the transmitter 503 to transmit the response to the node E. Upon receipt of the response addressed to the node D from the display 102 of the sink A, the node E transmits the response to the node D.

Upon receipt of the response to the release request from the node E, the response indicating non-release, the node D causes the controller 306 to generate information indicating that connection cannot be established and causes the transmitter 302 to transmit the information to the node F. Upon receipt of the information indicating that connection cannot be established from the node D, the node F transmits the information to the display 103 of the sink B to request the display 103 to notify the viewer/listener (user) that connection cannot be established because the set-top box 101 of the sink A is in use.

In this case, the display 103 of the sink B outputs a screen indicating that connection cannot be established because the set-top box 101 of the source A is in use (see FIG. 12), and cancels the request for connection to the set-top box 101 of the source A. Here, the screen information may be generated by the controller 504 of the display 103 of the sink B, or may be supplied with the screen information contained in the information from the node F indicating that connection cannot be established.

On the other hand, upon receipt of the response to the release request from the node E, the response indicating release, the node D notifies the entire network or the nodes A to E of the release of the connection between the set-top box 101 of the source A and the display 102 of the sink A. As a result, the connection between the set-top box 101 of the source A and the display 102 of the sink A is released, and processing of establishing the connection between the set-top box 101 of the source A and the display 103 of the sink B is performed. As described above, the connection between the display 103 of the sink B and the set-top box 101 of the source A is established, so as to allow the set-top box 101 of the source A to transmit the video signal to the display 103 of the sink B.

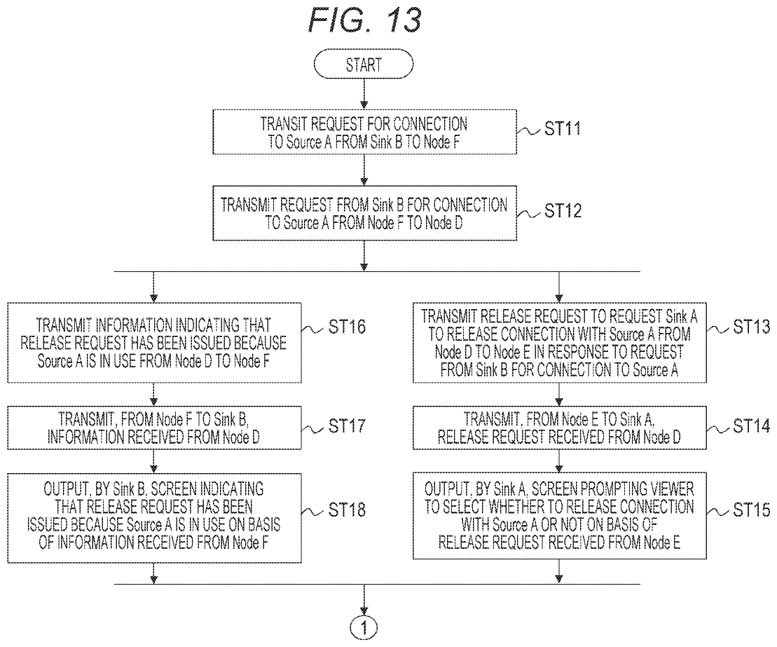

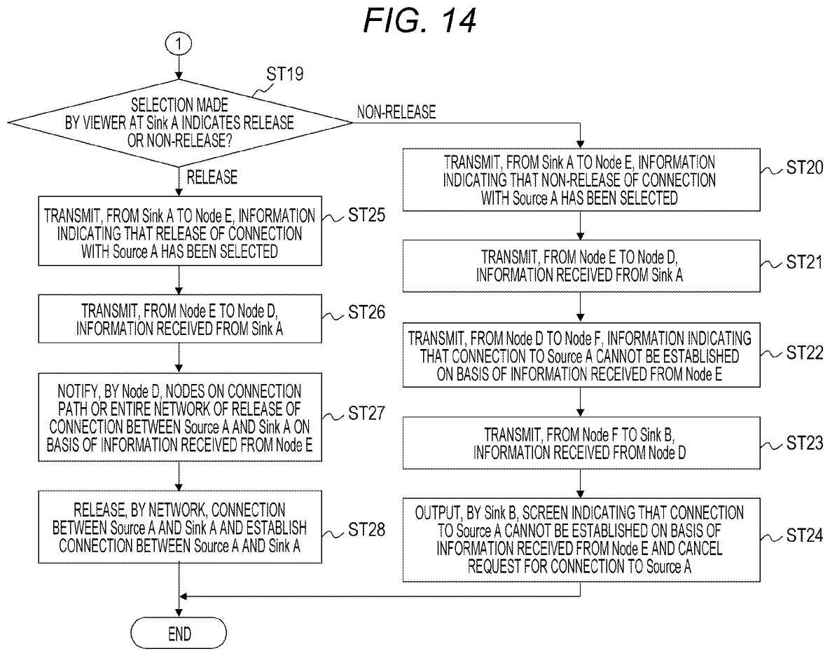

The flowcharts in FIGS. 13 and 14 illustrate an example of an operation in a case where a request for connection to the source A is issued from the sink B (display 103) with the path from the sink A (display 102) to the source A (set-top box 101) occupied by the nodes A to E on the path as described above.

First, in step ST11, the sink B transmits, to the node F, a request for connection to the source A. Next, in step ST12, the node F transmits, to the node D, the request from the sink B for connection to the source A.

Next, in step ST13, the node D transmits, to the node E, a release request for requesting the sink A to release the connection with the source A in response to the request from the sink B for connection to the source A. Next, in step 14, the node E transmits, to the sink A, the release request received from the node D. Next, in step ST15, the sink A outputs a screen prompting the viewer/listener (user) to select whether to release the connection with the source A or not on the basis of the release request received from the node E (see FIG. 11(a)).

Furthermore, in step ST16, the node D transmits, to the node F, information indicating that the release request has been issued because the source A is in use. Next, in step ST17, the node F transmits, to the sink B, the information received from the node D. Next, in step ST18, the sink B outputs, on the basis of the information received from the node F, a screen indicating that the release request has been issued because the source A is in use, and a request to wait for a while (see FIG. 11(b)).

Next, in step ST19, the sink A determines whether the response to the release request, that is, the selection made by the viewer/listener (user), indicates release or non-release. When the selection made by the viewer/listener is non-release, the processing proceeds to step ST20.

In step ST20, the sink A transmits information indicating that non-release of the connection with the source A has been selected to the node E. Next, in step ST21, the node E transmits, to the node D, the information received from the sink A. Next, in step ST22, the node D transmits, to the node F, information indicating that connection to the source A cannot be established on the basis of the information received from the node E.

Next, in step ST23, the node F transmits, to the sink B, the information received from the node D. Next, in step ST24, the sink B outputs a screen indicating that connection to the source A cannot be established on the basis of the information received from the node F (see FIG. 12), and cancels the request for connection to the source A.

Furthermore, when the selection made by the viewer/listener indicates release in step ST19, the processing proceeds to step ST25. In step ST25, the sink A transmits information indicating that release of the connection with the source A has been selected to the node E. Next, in step ST26, the node E transmits, to the node D, the information received from the sink A.

Next, in step ST27, the node D notifies the entire network or the nodes A to E of the release of the connection between the source A and the sink A on the basis of the information received from the node E. Next, in step ST28, the network releases, on the basis of the notification about the release of the connection, the connection between the set-top box 101 of the source A and the display 102 of the sink A, and establishes connection between the set-top box 101 of the source A and the display 103 of the sink B. Note that, when the connection between the set-top box 101 of the source A and the display 103 of the sink B is established as described above, the screen as illustrated in FIG. 11(b) on the display 103 of the sink B is removed.

As described above, the connection between the display 103 of the sink B and the set-top box 101 of the source A is established, so as to allow the set-top box 101 of the source A to transmit the video signal to the display 103 of the sink B.

Note that, although no detailed description will be given, in a case where information indicating that the path from the display 102 of the sink A to the set-top box 101 of the source A is occupied by the nodes A to E on the path is shared all over the network, the node F can perform the above-described processing in the node D.

Furthermore, a description has been given above of the configuration where, upon receipt of the request from the sink B for connection to the source A, the node D transmits the release request to the sink A, but, the node D may notify the entire network or the node E that there is a request for connection from the sink B, and the node E may transmit, upon receipt of this notification, the release request to the sink A.

In this case, when the viewer/listener selects the release of the connection at the sink A, the node E may notify, upon receipt of the information, the entire network or the nodes A to E of the release of the connection between the source A and the sink A. Furthermore, in this case, when the viewer/listener selects non-release at the sink A, the node E may notify, upon receipt of this information, the entire network or the node F via the node D, and the node F may generate, upon receipt of this notification, information indicating that connection cannot be established because the set-top box 101 of the sink A is in use, and transmit the information to the display 103 of the sink B.

As described above, in the present technology, in the above-described arbitration, all the processing is performed under the initiative of nodes on a path without requiring direct communications between terminal devices. That is, in the present technology, it is possible to arbitrate access from another person to a terminal that is in use without implementing an arbitration function in the terminal and without reducing a bandwidth allocated to a dedicated peer-to-peer path.

Note that, although no detailed description will be given, in the network system 200 illustrated in FIG. 4, in a case where the PC 203 of the source B transmits, to the node F, a request for connection to the robot 202 of the sink A with connection that is occupied via the nodes A to E between the PC 201 of the source A and the robot 202 of the sink A established, and the robot 202 of the sink A being under the control of (operated by) the PC 201 of the source A, the node A can transmit, in a similar manner, a release request to the PC 201 of the source A for arbitration.

### 2. Modification

Note that the above-described embodiments each correspond to a case where the present technology is applied to an optical network system that transmits an optical signal, but the present technology is also applicable, in a similar manner, to a network system that transmits an electric signal.

Furthermore, in the above-described embodiments, an example where the source is a set-top box, and the sink is a display, and an example where the source is a PC, and the sink is a robot have been described. It is a matter of course, however, that a combination of the source and the sink is not limited to the above.

Furthermore, the preferred embodiments of the present disclosure have been described in detail with reference to the accompanying drawings, but the technical scope of the present disclosure is not limited to such examples. It is obvious that those having ordinary skill in the art of the present disclosure can conceive various changes or modifications within the scope of the technical idea described in the claims, and it is to be understood that such changes or modifications also fall within the technical scope of the present disclosure.

Furthermore, the effects described herein are merely illustrative or exemplary, and should not be restrictively interpreted. That is, the technology according to the present disclosure can exhibit other effects that are obvious for those skilled in the art from the description given herein together with or instead of the above-described effects.

Furthermore, the present technology can also have the following configurations.

(1) A network device including
a controller that controls processing of receiving a request from a first terminal for connection to a second terminal, and processing of transmitting, when the second terminal is in use, a notification that connection cannot be established to the first terminal.

(2) The network device according to the above (1), in which
the controller recognizes that the second terminal is in use on the basis of connection information stored in a storage unit.

(3) The network device according to the above (1), in which
the controller recognizes that the second terminal is in use on the basis of connection information received from another network device that transmits the request from the first terminal for connection to the second terminal.

(4) A network device control method including:
a procedure of controlling processing of receiving a request from a first terminal for connection. to a second terminal; and
a procedure of controlling processing of transmitting, when the second terminal is in use, a notification that connection cannot be established to the first terminal.

(5) A network device present on a connection path between a first terminal and a second terminal, the network device including
a controller that controls processing of receiving a request from a third terminal for connection to the first terminal, and processing of transmitting, when receiving the request for connection, a release request to the second terminal.

(6) The network device according to the above (5), in which
the controller further controls, when transmitting the release request to the second terminal, processing of transmitting, to the third terminal, a notification that the release request has been issued.

(7) The network device according to the above (5) or (6), in which
the controller further controls, when transmitting the release request to the second terminal, processing of receiving a response to the release request from the second terminal.

(8) The network device according to the above (7), in which
the controller further controls, when the response from the second terminal indicates non-release, processing of transmitting a notification that connection cannot be established to the third terminal.

(9) The network device according to the above (7) or (8), in which
the controller further controls, when the response from the second terminal indicates release, processing of transmitting a notification to at least a network device on the connection path between the first terminal and the second terminal.

(10) A network device control method applied to a network device present on a connection path between a first terminal and a second terminal, the network device control method including:
a procedure of controlling processing of receiving a request from a third terminal for connection to the first terminal; and
a procedure of controlling processing of transmitting, when receiving the request for connection, a release request to the second terminal.

(11) A network system including a predetermined number of network devices interposed between terminals, in which,
among the predetermined number of network devices, at least the network device present on a connection path between a first terminal and a second terminal holds information regarding the connection path.

(12) The network system according to the above (11), in which
the predetermined number of network devices include a network unit and a switch/router.

### REFERENCE SIGNS LIST

1A, 1B Terminal

2A, 2B Network cable

3A, 3B Optical network unit

4A, 4B Multi-core fiber

5 Optical switch/router

6 Cloud

7 Storage

8 Wireless base station

11 Set-top box

12 HDMI cable

13 Display

14 PC

15 USB cable

16 Robot

100 Network system

101 Set-top box

102, 103 Display

200 Network system

201, 203 PC

202 Robot

300 Node

301, 304 Receiver

302, 305 Transmitter

303 Path selector

306 Controller

307 Storage unit

400 Set-top box

401 Transmitter

402 Content container

403 Receiver

404 Controller

405 Storage unit

500 Display

501 Receiver

502 Display unit

503 Transmitter

504 Controller

505 Storage unit

506 Input unit

1. A network device comprising
a controller that controls processing of receiving a request from a first terminal for connection to a second terminal, and processing of transmitting, when the second terminal is in use, a notification that connection cannot be established to the first terminal.

2. The network device according to claim 1, wherein
the controller recognizes that the second terminal is in use on a basis of connection information stored in a storage unit.

3. The network device according to claim 1, wherein
the controller recognizes that the second terminal is in use on a basis of connection information received from another network device that transmits the request from the first terminal for connection to the second terminal.

4. A network device control method comprising:
a procedure of controlling processing of receiving a request from a first terminal for connection to a second terminal; and
a procedure of controlling processing of transmitting, when the second terminal is in use, a notification that connection cannot be established to the first terminal.

5. A network device present on a connection path between a first terminal and a second terminal, the network device comprising
a controller that controls processing of receiving a request from a third terminal for connection to the first terminal, and processing of transmitting, when receiving the request for connection, a release request to the second terminal.

6. The network device according to claim 5, wherein
the controller further controls, when transmitting the release request to the second terminal, processing of transmitting, to the third terminal, a notification that the release request has been issued.

7. The network device according to claim 5, wherein
the controller further controls, when transmitting the release request to the second terminal, processing of receiving a response to the release request from the second terminal.

8. The network device according to claim 7, wherein
the controller further controls, when the response from the second terminal indicates non-release, processing of transmitting a notification that connection cannot be established to the third terminal.

9. The network device according to claim 7, wherein
the controller further controls, when the response from the second terminal indicates release, processing of transmitting a notification to at least a network device on the connection path between the first terminal and the second terminal.

10. A network device control method applied to a network device present on a connection path between a first terminal and a second terminal, the network device control method comprising:
a procedure of controlling processing of receiving a request from a third terminal for connection to the first terminal; and
a procedure of controlling processing of transmitting, when receiving the request for connection, a release request to the second terminal.

11. A network system comprising a predetermined number of network devices interposed between terminals, wherein,
among the predetermined number of network devices, at least the network device present on a connection path between a first terminal and a second terminal holds information regarding the connection path.

12. The network system according to claim 11, wherein
the predetermined number of network devices include a network unit and a switch/router.
